(19) United States
(12) Patent Application Publication
(10) Pub. No.: US 2014/0229378 A1
(43) Pub. Date: Aug. 14, 2014

(54) SYSTEMS AND METHODS FOR AUTHENTICATION NOTIFICATION

(71) Applicant: DESIRE2LEARN INCORPORATED, Kitchener (CA)

(72) Inventor: Brian PEARSON, Kitchener (CA)

(73) Assignee: DESIRE2LEARN INCORPORATED, Kitchener (CA)

(21) Appl. No.: 13/767,345

(22) Filed: Feb. 14, 2013

(51) Int. Cl. G06Q 20/40

(52) U.S. Cl. CPC G06Q 20/4016
USPC 705/44

(57) ABSTRACT

A processor implemented method and system for preventing fraudulent transactions between users and vendors. The method includes: receiving, at a server, information relating to a transaction between a user and a vendor, the server receiving the information from at least one vendor transaction processing unit, the server comprising at least one server processor and being coupled to at least one data storage device; locating on the at least one storage device contact information relating to the at least one user, the contact information comprising at least one communications address for at least one customer-registered unit associated with the user; and c) transmitting transaction information to the at least one user-registered unit over the at least one communications network.

### FIELD

The present disclosure relates generally to systems and methods for authentication notification and, more particularly, to systems and methods for preventing fraudulent transactions.

### BACKGROUND

Transactions of various types, such as for example, financial transactions, are increasingly executed online. An example of a transaction that is often executed online is the purchase of a good or service. Traditionally, such a transaction was often executed face to face between two people. For example, in the case of a purchase of a book, a person would often enter a bookstore and perform the purchase transaction with a cashier. In contrast, when the transaction is executed online, the purchaser will generally use a first computing device to perform the transaction with a second computing device operated by a vendor. The transaction is generally executed through a communications network such as, for example, the Internet.

The above information is presented as background information only to assist with an understanding of the present disclosure. No determination has been made, and no assertion is made, as to whether any of the above might be applicable as prior art with regard to the present invention.

### SUMMARY

In a first aspect, the present disclosure provides a system for preventing fraudulent transactions, the system comprising: a) a vendor transaction processing unit coupled to a first communications network, the at least one vendor transaction processing unit being configured to: perform transactions with users over the first communications network, and transmit information associated with a transaction, the information comprising a user identification (ID) associated with the transaction; b) a verification server having a processor and coupled a storage unit, a second communications network and the a vendor transaction processing unit, the server being configured to: receive the information transmitted by the vendor transaction processing unit, locate a communication address for a user-registered mobile communication device associated with the user ID, and transmit transaction information to the user-registered mobile communication device over the second communications network.

In some embodiments, the transaction information comprises at least a portion of the information associated with the transaction transmitted by the at least one vendor transaction processing unit.

In some embodiments, the vendor transaction processing unit is further configured to receive instructions generated by the user-registered mobile communication device.

In some embodiments, the instructions comprise at least one of: (i) authentication; (ii) validation; (iii) cancellation; (iv) holding the transaction; (v) temporary cancellation of an account with the vendor; (vi) temporary cancellation of an account with an intermediary and (vi) flagging the transaction for further investigation.

In some embodiments, the verification server is configured to transmit the transaction information to the user-registered mobile communication device contemporaneously with the transaction. In various embodiments, the term contemporaneously means after the transaction has been initiated but prior to the transaction being completed. In some embodiments, this enables the user to cancel a transactions that the user does not intend on honoring. For example, as explained in greater detail below, in some embodiments, in response to receiving the transaction information, the user has the option to cancel or refuse the transaction.

In some embodiments, the transaction information includes details of the transaction. In various embodiments, the details of the transaction include at least one of: (i) vendor information; and (ii) consideration being exchanged by at least one party to the transaction.

In some embodiments, the user-registered unit is registered with an intermediary of the transaction.

In some embodiments, the transaction is executed if the user fails to cancel or hold the transaction within a predetermined period of time from a point in time at which the vendor transaction processing unit transmits the information associated with the transaction to the server.

In some embodiments, if the user temporarily cancels the account with the vendor or temporarily cancel the account with the intermediary, no further transactions are processed until the user reactivates the account.

In some embodiments, the intermediary recognizes communications from the user-registered unit as being authentic if the communications include a certificate.

In some embodiments, communications from the at least one customer-registered unit are in the form of at least one of: (i) telephony; (ii) electronic mail; (iii) instant messaging; (iv) fax; (v) paging; (vi) Short Message Service (SMS); and (vii) submissions to a hosted site.

In another aspect, the present disclosure provides a mobile communication device comprising: communication module configured to receive transaction information over a first communication network, the transaction information identifying a transaction entered into using a user identification (ID) associated with the mobile communication device; a processor configured to generate a transaction alert based on received transaction information; and an output device for outputting the transaction alert.

In some embodiments, the alert comprises a sound. In various embodiments, the sound is distinctive of a transaction alert. The use of a distinctive transaction alert, in some embodiments, enables the user to recognize that a transaction is pending without requiring the user to analyze the specific details of the pending transaction. In various embodiments, the use of a distinctive transaction alert enables the user to recognize the presence of a potentially fraudulent transaction based on the distinctive alert in the context of the user's current activity.

In various embodiments, the alert comprises information identifying the transaction.

In various embodiments, the output device comprises a speaker, display, LED, or a combination thereof.

In some embodiments, the device further comprises an input device; wherein the processor is further configured to transmit instructions to a server associated with the transaction based on user input at the input device.

In some embodiments, the instructions comprise at least one of: (i) authentication; (ii) validation; (iii) cancellation; (iv) holding the transaction; (v) temporary cancellation of an account with the vendor; (vi) temporary cancellation of an account with an intermediary and (vi) flagging the transaction for further investigation.

In some embodiments, the mobile communication device receives the transaction information contemporaneously with the transaction.

In some embodiments, the transaction information includes details of the transaction.

In some embodiments, the details of the transaction include at least one of: (i) vendor information; and (ii) consideration being exchanged by at least one party to the transaction.

In some embodiments, communications transmitted by the mobile communication device are in the form of at least one of: (i) telephony; (ii) electronic mail; (iii) instant messaging; (iv) fax; (v) paging; (vi) Short Message Service (SMS); and (vii) submissions to a hosted site.

In another aspect, the present disclosure provides a processor implemented method of preventing fraudulent transactions between users and a vendors, the method comprising: a) receiving, at a server, information relating to a transaction between a user and a vendor, the server receiving the information from at least one vendor transaction processing unit, the server comprising at least one server processor and being coupled to at least one data storage device; b) locating on the at least one storage device contact information relating to the at least one user, the contact information comprising at least one communications address for at least one customer-registered unit associated with the user; and c) transmitting transaction information to the at least one user-registered unit over the at least one communications network.

In some embodiments, the method further comprises polling the at least one communications network for a response from the at least one user-registered unit, the polling being performed for a predetermined period of time from a point in time at which transaction information is transmitted to the at least one user-registered unit.

In some embodiments, if a response from the at least one customer registered unit is received within the predetermined period of time, then the at least one server executes instructions associated with the at least one user's response.

In some embodiments, the instructions include at least one of: (i) authentication; (ii) validation; (iii) cancellation; and (iv) notification that the transaction is flagged for further investigation.

In some embodiments, if the at least one server does not receive a response from the at least one customer-registered unit within the predetermined period of time, then the at least one server transmits approval of the transaction to the at least one vendor transaction processing unit.

In some embodiments, the at least one server transmits transaction information contemporaneously with the transaction thereby enabling the at least one user to cancel transactions that the at least one user does not intend on honoring.

In some embodiments, the transaction information that is transmitted to the at least one customer-registered unit includes details of the transaction.

In some embodiments, the details of the transaction include at least one of: (i) vendor information; and (ii) consideration being exchanged by at least one party to the transaction.

In some embodiments, the at least one customer-registered unit is registered with an intermediary of the transaction.

In some embodiments, the intermediary of the transaction considers communications which are contemporaneous with the transaction and which are from the at least one customer-registered unit to be genuine intentions of the at least one user.

In some embodiments, further comprises: receiving communications from the at least one customer-registered unit, such communications being contemporaneous with the transaction, and such communications reflecting the at least user's instructions to perform at least one of the following functions: (i) cancelling the underlying transaction; (ii) placing a hold on the underlying transaction; (iii) temporarily cancelling an account with the vendor; and (iv) temporarily cancelling an account with the intermediary.

In some embodiments, the at least one user temporarily cancel the account with the vendor or temporarily cancel the account with the intermediary, then the at least one server rejects the transaction and prevents approval of further transactions that are processed until such time that the at least one server receives an instruction from the at least one user that relates to reactivation of the respective account.

In some embodiments, transmitted transaction information includes an alert that provides the at least one user with notice of a pending transaction, the alert being a distinctive alert that enables the at least one user to recognize that a transaction is pending without requiring the at least one user to analyze the specific details of the pending transaction.

In some embodiments, the distinctive alert enables the at least one user to recognize the presence of a potentially fraudulent transaction based on the transmission of the alert in the context of the at least one user's current activity.

In some embodiments, the method further comprises: characterizing communications from the at least one customer-registered unit as being authentic if the communication includes at least a certificate in conjunction with the at least one user's communication.

In some embodiments, communications from the at least one customer-registered unit are in the form of at least one of: (i) telephony; (ii) electronic mail; (iii) instant messaging; (iv) fax; (v) paging; (vi) Short Message Service (SMS); and (vii) submissions to a hosted site or a website.

Other aspects and features of the present disclosure will become apparent to those of ordinarily skill in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a block diagram of a system according to various embodiments; and

FIG. 2 is a flowchart diagram of a method according to various embodiments.

Throughout the drawings, it should be noted that like reference numbers are used to depict the same or similar elements, features, and structures.

### DETAILED DESCRIPTION

Generally, the present disclosure provides methods and systems for authentication notification and, more particularly, to systems and methods for preventing fraudulent transactions that occur through a network, such as, for example, the Internet. Such transactions are often referred to as “online transactions”. The term transaction, as used herein, refers to any transaction that may be executed between a user and a second party, including but not limited to, any changes to an online user account or a financial transaction. The change can include but is not limited to a change of password or any information associated with the account including but limited to financial and personal information.

Online transactions can be susceptible to fraudulent behavior when one individual can pass themselves off as another individual. Secret passwords (or other secret/security information) are generally used in conjunction with a user name to verify the identify of a user. However, if an unauthorized party discovers a user's password, the unauthorized party may be able to execute unauthorized transactions in the user's name. Moreover, the user may not have the ability to discover the fraudulent transactions until well after their execution. By the time the user becomes aware of the transaction it may not be possible to reverse or cancel the transaction without significant loss or inconvenience to either the user or another party to the transaction who may have believed that they were executing a transaction with the user.

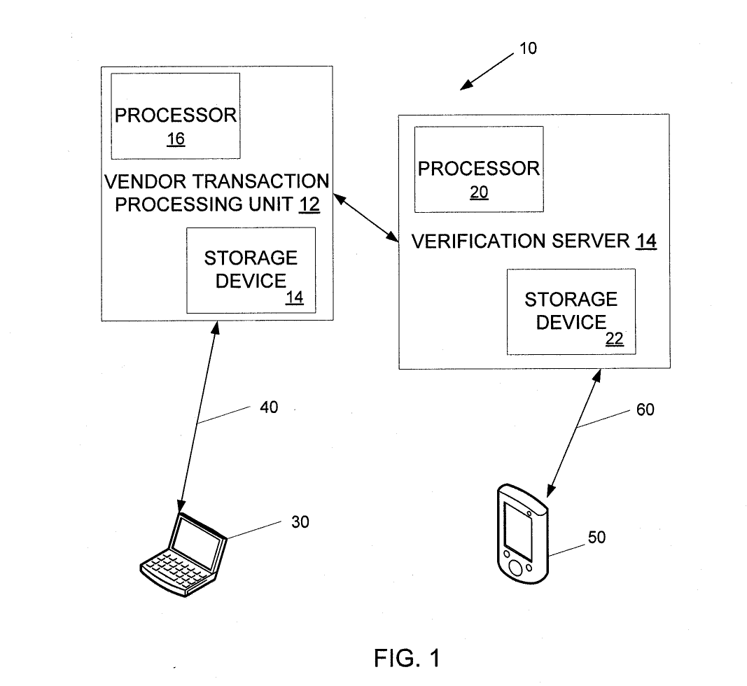

Reference is now made to FIG. 1, which illustrates a block diagram of a notification system 10, according to various embodiments. System 10 includes a vendor transaction processing unit 12 and a verification server 14. In some embodiments, vendor transaction processing unit 12 and verification server 14 are distinct devices. For example, vendor transaction processing unit 12 may be operated by a vendor and verification server 14 may be operated by a third party at a separate location. In other embodiments, the same computing device can be used to implement the functionality of both the vendor transaction processing unit 12 and verification server 14. In embodiments where vendor transaction processing unit 12 and verification server 14 are distinct devices, the vendor transaction processing unit 12 and the verification server 14 are coupled through any appropriate communications channel including but not limited to one or more networks which can include the Internet.

Vendor transaction processing unit 12 includes a processor 16 and is coupled to a storage device 18. Verification server 14 includes a processor 20 and is coupled to a storage device 22. In some embodiments, storage device 22 is included as part of verification server 14. In other embodiments, storage device 22 is separate from verification server 14 and is coupled to the verification server 14 through any suitable communication channel. In various embodiments processors 16 and 20 comprise one or more physical processors, such as for example but not limited to central processing units or microprocessors.

Vendor transaction processing unit 12 is utilized to process transactions initiated in the name of a user using any suitable computing device 30. In various embodiments computing device 30 may be any suitable computing device, including, but not limited to, a personal computer, a laptop, a notebook, a tablet, a smart phone, or the like. Computing device 30 generally includes a processor, one or more output devices (e.g., a display), a memory device, a communication system, and an input device. Computing device 30 is used to run one or more applications that interact with vendor processing unit 12 to initiate and execute transactions. Computing device 30 communicates with vendor transaction processing unit through a first communications network 40, such as for example, but not limited to, the Internet or a telephone cellular network.

In various embodiments, when a transaction has been initiated, vendor transaction processing unit 12 transmits information regarding that transaction to verification server 14. In various embodiments, the information regarding the transaction includes information identifying a user who is a party to the transaction. In some embodiments, the information regard the transaction includes details regarding the transaction such as the nature of the transaction. For example, the information may identify the type of the transaction (e.g., a purchase of a good or change to a profile), the item being purchased if the transaction is a purchase of a good or service, if funds are being exchanged and how much, and the like. The verification server 14 utilizes the information received from vendor transaction processing unit 12 to locate contact information stored in storage device 22 for the user that has been identified as a party to the transaction.

Verification server 14 is coupled to user mobile device 50 through a second communications network 60, such as for example, but not limited to, a telephone cellular network or the Internet. In some cases, the first and second communications network may be the same. The verification server 14 sends a message to mobile device 50 in order alert the user that a transaction has been initiated to which the user is a party (e.g., via the mobile device 50). As will be explained in greater detail below, in some embodiments, the user is able to act on this information to affect the transaction if so desired.

In various embodiments, mobile device 50 may be, but is not limited to, a mobile computing device, such as a smart phone or tablet. In some embodiments, mobile device 50 includes a communication module configured to receive transaction information over a first communication network, the transaction information identifying a transaction entered using a user identification (ID) associated with the mobile communication device; a processor configured to generate a transaction alert based on received transaction information; and an output device for outputting the transaction alert. In some embodiments, the output device includes one or more of a speaker, display, and a LED.

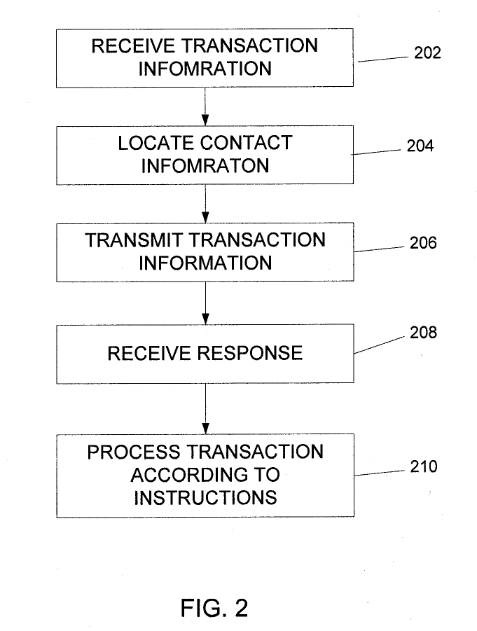

Reference is now made to FIG. 2, which is a flow chart diagram which illustrates a flowchart diagram of a method of notifying a user of a transaction to which the user is a party.

At step 202, verification server 14 receives transaction information from vendor transaction processing unit 12. In various embodiments, the transaction information includes information identifying a user that is a party to the transaction. The transaction could have been initiated by for example the user utilizing computing device 30. The transaction may also have been initiated by an unauthorized party impersonating the user through for example the use of password and login information that may have been obtained through illicit means.

At step 204, verification server 14 locates contact information for the user based on the transaction information. In various embodiments, verification server retrieves the user's contact information from storage device 22. In some embodiments, the contact information includes information particular to a specific mobile device 50. In such embodiments, mobile device 50 can be referred to as a user-registered unit. In some embodiments, verification server 14 is operated by an intermediary to the transaction and mobile device 50 is registered with the intermediary.

At step 206, verification server 14 transmits transaction information to the user's mobile device 50 based on the contact information retrieved at step 204. In various embodiments, the transaction information transmitted to the user's mobile device 50 is at least a portion of the transaction information received from vendor transaction processing unit 12 at step 202. In some embodiments, verification server 14 is configured to transmit the transaction information to the user-registered mobile communication device contemporaneously with the transaction. In various embodiments, the term contemporaneously means after the transaction has been initiated but prior to completion of the transaction. Accordingly, in various embodiments, verification server 14 is configured to transmit the transaction information while the transaction is pending.

In various embodiments, mobile device 50 is configured to generate a transaction alert in response to receipt of transaction information from verification server 14. In some embodiments, the alert comprises sound. In some embodiments, mobile device 50 is configured to only permit certain sounds to be used for alert. In other embodiments, mobile device 50 is configured such that, if a specific sound is utilized for a transaction alert, that same sound cannot be used for other purposes. In various embodiments, the transaction alert can also include flashing lights or vibrations. In various embodiments, where flashing lights are utilized for the transaction alert, a characteristic of the flashing light (e.g., pattern of flashing or the colors used) is unique to the transaction alert. Similarly, in some embodiments, the pattern of vibrations is also unique to a transaction alert. In some embodiments the transaction alert includes a combination of one or more alerts, including sound, light, vibration, and the like.

In various embodiments, the transaction alert is a distinctive alert. This allows the user to immediately recognize the alert as a transaction alert without having to review or analyze a message to determine that a transaction is in progress.

In various embodiments, mobile device 50 presents details of the transaction to the user when a transaction alert has been generated. In some embodiments, the details of the transaction can include, but is not limited to, vendor information or money/consideration being exchanged by at least one party to the transaction

In some embodiments, in response to the transaction alert, the user is able to generate instructions for processing the transaction. In various embodiments, mobile device 50 includes an input device, such as for example, a keypad or a touch screen that the user can use to input their instructions. In various embodiments, the instructions can include but are not limited to: authentication, validation, cancellation, holding the transaction, temporary cancellation of an account with the vendor, temporary cancellation of an account with an intermediary, or flagging the transaction for further investigation. In various embodiments, the options may be automatically presented to the user on an output of the mobile device 50. Accordingly, by transmitting transaction information from the verification server 14 to the mobile device 50, the user is provided the opportunity to prevent a fraudulent transaction from being completed.

In some embodiments, the communications (e.g., including the instructions) are sent from mobile device 50 in a form that can include, but is not limited to, telephony, electronic mail, instant messaging, fax, paging, Short Message Service (SMS), Multimedia Messaging Service (MMS), submissions to a hosted site, and the like.

At step 208, verification server 14 receives the instructions from the user that are sent from mobile device 50. In various embodiments where mobile device 50 is registered, verification server 14 recognizes communications from mobile device 50 if the communications include a certificate. In various embodiments, instructions received from a registered mobile device 50 at verification server 12 are considered to be the genuine intentions of the user. Accordingly, in some embodiments, an assumption is made that only the registered user has access and/or control of mobile device 50.

In some embodiments, if the user does not provide instructions within a predetermined period of time, then the transaction is executed. For example, if verification server 14 does not receive a response from mobile device 50 within a predetermined period of time, then verification server 14 transmits approval of the transaction to vendor transaction processing unit 12. In various embodiments, if the user cancels (temporarily or indefinitely) the account with the vendor or temporarily cancels the account with the intermediary, then no further transactions are processed until the user reactivates the account.

At step 210, verification server 14 acts on the response provided by the user by, for example, communication with the vendor transaction processing unit 12. In some embodiments, the vendor transaction processing unit 12 is configured to receive the user's response from mobile device 50. In some such embodiments, steps 208 and 210 described above are not executed by verification server 14 and vendor transaction processing unit 12 acts on the user's response directly.

In some embodiments, the method further includes polling second communications network 60 for a response from a user-registered unit, such as mobile device 50. In some embodiments, the polling is performed for a predetermined period of time from the point in time at which transaction information is transmitted to the user-registered unit 50. In some embodiments, if a response is received from the user-registered unit within the predetermined period of time, then verification server 14 or vender transaction processing unit 12 executes instructions associated with the at least one user's response.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

1. A system for preventing fraudulent transactions, the system comprising:
a vendor transaction processing unit coupled to a first communications network, the at least one vendor transaction processing unit configured to:
perform transactions with users over the first communications network, and transmit information associated with a transaction, wherein the information comprises a user identification (ID) associated with the transaction;
a verification server having a processor and coupled to a storage device unit, a second communications network and the a vendor transaction processing unit, the server configured to:
receive the information transmitted by the vendor transaction processing unit, locate a communication address for a user-registered mobile communication device associated with the user ID, and
transmit transaction information to the user-registered mobile communication device over the second communications network.

2. The system of claim 1, wherein the transaction information comprises at least a portion of the information associated with the transaction transmitted by the at least one vendor transaction processing unit.

3. The system of claim 1, wherein the vendor transaction processing unit is further configured to receive instructions generated by the user-registered mobile communication device.

4. The system of claim 3, wherein the instructions comprise at least one of: (i) authentication; (ii) validation; (iii) cancellation; (iv) holding the transaction; (v) temporary cancellation of an account with the vendor; (vi) temporary cancellation of an account with an intermediary; and (vi) flagging the transaction for further investigation.

5. The system of claim 3, wherein the verification server is configured to transmit the transaction information to the user-registered mobile communication device contemporaneously with the transaction.

6. The system of claim 1, wherein the transaction information comprises at least one of: (i) vendor information; and (ii) consideration being exchanged by at least one party to the transaction.

7. The system of claim 1, wherein the user-registered mobile communication device is registered with an intermediary of the transaction.

8. The system of claim 4, wherein the transaction is executed if the user fails to cancel or hold the transaction within a predetermined time from a point in time at which the vendor transaction processing unit transmits the information associated with the transaction to the server.

9. The system of claim 7, wherein the intermediary recognizes communications from the user-registered mobile communication device as being authentic if the communications include a certificate.

10-24. (canceled)

25. The system of claim 1, wherein the transactions performed with users over the first communication network are initiated by a computing device.

26. The system of claim 25, wherein the computing device is a separate computing device than the user-registered mobile communication device.

27. The system of claim 1 wherein the user-registered mobile communication device is configured to alert the user after reviving the transaction information.

28. The system of claim 27, wherein the alert is distinctive from other alerts provided by the user-registered mobile communication device.
